(19) United States
(12) Patent Application Publication
(10) Pub. No.: US 2021/0374925 A1
(43) Pub. Date: Dec. 2, 2021

(54) Image Enhancement System and Method

(71) Applicant: Apple Inc., Cupertino, CA (US)

(72) Inventors: Graham Finlayson, Norwich (GB); Alex Hayes, Ely (GB)

(21) Appl. No.: 17/321,024

(22) Filed: May 14, 2021

Related U.S. Application Data
(63) Continuation of application No. PCT/GB2019/053251, filed on May 22, 2020.

(30) Foreign Application Priority Data
Nov. 15, 2018 (GB) 1818647.8

(51) Int. Cl. G06T 5/50; G06T 5/20

(52) U.S. Cl. CPC G06T 5/50; G06T 2207/20016; G06T 2207/20221; G06T 5/20

(57) ABSTRACT

An image enhancement method and system is described. The method comprises receiving an input and target image pair, each of the input and target images including data representing pixel intensities; processing the data to determine a plurality of basis functions, each basis function being determined in dependence on content of the input image, determining a combination of the basis functions to modify the intensity of pixels of the input image to approximate the target image; and applying the plurality of basis functions to the input image to produce an approximation of the target image.

### FIELD OF THE INVENTION

The present invention relates to an image enhancement method and system that generate modified digital images and may also generate fused images. In certain cases, the present invention may also be extended to digital video enhancement.

### BACKGROUND TO THE INVENTION

An image can be digitally represented as a scalar function of brightness intensity I(x,y) (x and y are the Cartesian coordinates with brightness coded by a digital count I(x,y)=brightness intensity). An image can also be digitally represented as a vector function I(x,y) (where there is a vector I of respective intensity of Red, Green and Blue values—R, G and B—at a spatial location). It will be appreciated that other coordinate systems can be used and images can also be represented by other intensity encoding models (such as the CMYK representation commonly used in printing, for example). I(x,y) can be defined over any domain and may encode pixel brightnesses in different units including linear and logarithmic encodings

Image enhancement is done in many ways, generally by manipulating (via computational processing) the image's pixels with the intention of improving the image in some way. In some cases, this results in the image's pixel intensities being manipulated—for example equalizing brightness intensity levels or intensity of individual colour channels. In other cases, the content of the image itself may be manipulated, for example to change a background, remove unwanted elements or add elements. The actual improvement/enhancement varies depending on the particular application. In some cases, producing just aesthetically pleasing images is the main goal, while other applications might emphasize reproducing as many image details as possible, maximizing the image contrast, or changing parts of an image.

The discussions below focus on two different areas:
Intensity manipulation; and,
Content manipulation.

In the case of intensity manipulation, the intention is to substantially preserve the content of the image while manipulating intensity levels of pixels to achieve a desired effect. It will be appreciated that intensity could refer to intensity of greyscale or one or more colour channels.

In content manipulation, the image is changed in a way that is dependent on the content (and may result in a change in content)—typically by replacement or manipulation of selected pixels or pixel groupings in the image which correspond with certain content areas. It should be noted that intensity and content manipulation are not mutually exclusive and there can be crossover—for example content manipulation may include elements of intensity manipulation so that the added content fits in context with the rest of the image and does not look out of place.

The initial stage in both intensity and content manipulation is to select the image components or regions to be manipulated. In intensity manipulation, this is typically done algorithmically with fixed parameters. One type of approach is image segmentation in which a digital image is partitioned into multiple segments (sets of pixels). Image segmentation may be via intensity, clustering, edge detection, semantic content or other approaches (or combinations of approaches). Once segmented, the image can be manipulated—for example, in a simplistic example, pixels can be segmented according to a threshold intensity and those below the threshold can then be lightened. Sometimes, as segmentation performance improves, so too does the accuracy and effectiveness of the manipulation. However, resource utilization also typically increases as segmentation performance improves.

Content Manipulation

In the case of content manipulation, segmentation typically is separate to the actual manipulation. Image segmentation techniques are typically used to define a mask that guides selection of pixels to be manipulated. For example, in the case of background removal/replacement, a mask is created that delineates the edges of the foreground to be preserved and the pixels of the remainder, the background, can then be removed, replaced etc.

Mask creation often includes user input to guide selection of what is and is not foreground. Often there will not be clear colour/intensity delineation between foreground and background. Detail such as hair and shadows are considered particularly challenging to accurately capture within a mask. It is not unusual for photographers to have to refine computer-generated masks and pick out the detail missed by the computer when generating the mask—the content manipulation embodiments set out below perform a similar role automatically.

Intensity (and Colour) Manipulation

In intensity manipulation, image segmentation may also be important for accuracy in certain approaches (although not all intensity manipulation approaches use segmentation).

The underlying workflow in image enhancement typically performed for histogram equalization is shown in FIG. 1. In the top row of the Figure there is shown an input image FIG. 1a followed by the same image split into tiles in FIG. 1b and then in FIG. 1c the output of a contrast enhancement algorithm applied to each tile. The computation per tile is a simple tone curve: a mapping from input to output brightnesses. The tone curves for the 9 image regions are shown in FIG. 1d. It will be appreciated that the output 1c is not acceptable as the division into the 9 tiles can be seen in the output image.

One way that has been suggested to avoid the tile division appearing in the output image is to take each per-tile computation (encapsulated in this case as a tone curve) and apply it to the whole image, in this case yielding 9 full size image outputs. The 9 inputs can then be interpolated depending on a fixed interpolation scheme. One such fixed interpolation scheme is a ‘radial basis’ function type interpolation. In FIG. 1e 9 Gaussian functions are shown (of the size of the original image shown in 1a). At a given x- and y-spatial location the values of the 9 Gaussians can be looked up and this can then be used as a guide to interpolate the outputs of the 9 tone maps shown in FIG. 1d. Specifically, at an x- y-location the 9 Gaussians yield 9 probabilities. Scaling this vector to sum to one, we can use the resulting vector to weight the contribution of each tone mapped image. The resulting image calculated using this interpolation scheme on the tone curves of FIG. 1d and then applying to the input of FIG. 1a is shown in FIG. 1f.

Although, the final output, 1f), shows better visibility of detail everywhere in the image, compared to 1c), the level of detail that is visible is much more muted. Indeed, this is a limitation of this approach. By applying a fixed spatial interpolation (here a Gaussian radial basis function) there is a limit on how local the computation might be. While one might use more Radial basis functions to address this, such an approach leads to more computational complexity. Further, the more ‘local’ the computation, the more the resulting image will look like 1c (i.e. ‘blocky’), which would be unacceptable. Indeed, in existing systems, unless quite smooth interpolation is used the final output images will have spatial artifacts.

The above two approaches are known as “global” and “local” processing.

Global processing methods map each unique input brightness—regardless of where it appears in the image—to a corresponding unique output. As an example, assuming I(x,y) is a scalar value in the interval [0,1], then I(x,y)*1.5 will make all the pixels brighter (by 50%). A putative advantage of global methods is that because each unique input value maps to a unique output value the spatial coherence of the image is preserved.

Local or spatial processing methods—by far the most common type of image processing. Local processing methods typically repeat the same operation at different locations and, so, there is no guarantee that the same input brightness at two different locations will map to the same output. As an example, suppose an image is blurred by locally averaging. This operation can be denoted I(x,y)->blur(I(x,y))=I′(x,y). If, in the input image, I(a,b)=u=I(c,d) it is not necessarily the case that I′(a,b)=I′(c,d) (indeed, if it were the case then the method would in effect be implementing global processing).

One of the issues with local processing is that it does not preserve the spatial coherence of the input image. In the blur example, well-defined high contrast edges will become less strong after local averaging: the image will look softer and some fines grained detail may be lost altogether.

In the left panel of FIG. 2, there is shown an input image. The middle panel shows the output of global processing where the brightness is increased by 50%. The right panel shows the blurring (local spatial processing) of an image.

There are in-between methods that attempt to preserve some of the simplicity of global methods but allow some locality of computation (according to the workflow in FIG. 1). As an example, histogram equalization is a global method where the input image brightness are mapped (in a one-to-one way) such that the generated output histogram is made uniform (or as uniform as possible). In general, histogram equalization produces an output image where there is more detail. A dark image will become lighter—details in the shadows can pop out—and a bright image will become darker (clouds can look better defined).

In the left two panels of FIG. 3 there is shown an image and its histogram. In the 3^{rd} and 4^{th} panels there is shown, respectively, the image post-histogram equalization and its new histogram. Notice post-histogram-equalization, the histogram is nearly uniform. It is not completely flat because of quantization (to make it flat some input pixels with the same brightness would need to map to different output brightnesses). Panel 1 is mapped to Panel 3 using the tone curve shown in Panel 5.

The histogram equalization processing is visualized as a tone curve operation in the 5th panel. This simple graph simply (and completely) accounts for how the input brightnesses are mapped to output brightnesses.

Clearly, histogram equalization can change the ‘look’ of an image. The output image (3^{rd} panel of FIG. 2) is brighter and has more contrast than the input image. Notice however there is now an ‘edge’ in the sky. The reason for this ‘false contour’ is explicable by looking at the tone curve (fifth panel). Here many input brightnesses are mapped to a similar output brightness (inputs in range 0.4 through 0.8 are all mapped to about 0.8 in the output). This includes the darker part of the sky that, in terms of brightness, is pushed down relative to the brighter part and so an edge is formed. False contouring and ‘too much detail’ are two common problems encountered in using histogram equalization.

In FIG. 4, the output from the ‘contrast limited’ histogram equalization method is shown (https://en.wikipedia.org/wiki/Adaptive_histogram_equalization). The idea behind this method is that when histogram equalization is viewed as a tone curve the slope of the curve should neither be too steep nor too shallow.

The left image of FIG. 4 shows the output of contrast limited histogram equalization applied to the input (left image of FIG. 2). The image histogram is shown in the middle of the figure. Notice the histogram is more uniform than the input (2^{nd} panel, FIG. 3). The visualization of the contrast limited histogram equalization as a tone curve is shown in the right image of FIG. 4 (here the slope is bounded to be more than 0.5 and less than 2).

Arguably, the image in FIG. 4 is now ‘not processed enough’ compared to the full histogram equalization shown in FIG. 3. While there is no artifact in the sky, the output seems to be lacking in the contrast compared to FIG. 3 (panel 3).

In CLAHE (Contrast Limited Adaptive Histogram Equalisation), a different tone curve—again with a bounded slope—is calculated in different image tiles (the image is divided into (say) 16×16 non-overlapping rectangular regions, or tiles). The curve that is applied at a given pixel is an interpolation of the tone-curves calculated in the current tile and the surrounding tiles. The result of CLAHE is shown if FIG. 5. The lefthand panel shows CLAHE output, the middle the resulting brightness histogram and the right hand panel the input brightnesses (for left, FIG. 1) against output brightnesses (left panel).

The output image is certainly dramatic. Arguably, however, too much processing is in evidence. There is very high contrast throughout the image. The false contour in the sky has also returned. Note, because CLAHE is the interpolation of—in this case—256 tone curves in a 16×16 grid), when input is plotted against output brightnesses, a scatter plot of points is seen rather than a line. CLAHE is, by definition, a local and spatially varying image enhancement algorithm.

Many existing image processing methods can be seen as a compromise between local/spatial (depending on x- and y-location) and global (depending on the input brightness or vector). For example, in Bilateral Filtering (https://en.wikipedia.org/wiki/Bilateral_filter) an image is blurred but the relative magnitude of the brightness values is taken into account. In Bilateral filtering the blur is in addition weighted according to how similar the pixels in the local area are to the pixel at a given x-, y-location (i.e. the middle).

In WO 2011/101662, the output of any image enhancement algorithms—which may have egregious spatial artifacts such as ‘halos’, false contours or too much contrast—is approximated by a spatially varying lookup table operation, where the look-up tables are calculated according to optimization (and, like other prior art approaches, according to a fixed spatially varying interpolation). In FIG. 6 the output of such an approximation is shown (Left, input image. Middle, output of CLAHE. Right, Approximation using spatially varying LUTs).

More generally, it is common to decompose an image according to a known spatial decomposition, apply processing on the individual components and then invert the decomposition. As an example in the JPEG image compression standard, each 16 pixel×16 pixel block in an image is coded according to the Discrete Cosine Transform. That is, the block is represented by the sum of ‘basis’ functions which are part of the 2D cosine expansion. The first ‘basis’ function; in this expansion is C₁(x,y)=1. The second and third are C₂(x,y)=cos(x/2) and C₃(x,y)=cos(y/2). If solved for the DCT coefficients with respect to these 3 functions a, b, c can be found such that ∥block(x,y)-aC₁(x,y)-bC₂(x,y)-cC₃(x,y)∥ is as small as possible. Clearly, if a 16×16 block is approximated by 3 numbers—(a,b,c)—then a large compression of the information is achieved. Other basis functions that might be used include regularly distributed Gaussian functions.

The application of WO 2011/101662 shown in FIG. 6 assumed that the spatially varying aspect of the computation (mapping the left image to the middle) is defined by the first 3 terms in a discrete cosine basis expansion: the per pixel processing is linear combination of 3 computed output images where the per-pixel combination is defined by the DCT values at that pixel location)—resulting in the image shown on the right. The same approach and parameters are used irrespective of the input image. See FIG. 7 for a visualization of the first 3 basis images in the 2-dimensional Discrete Cosine Transform. Note because the DCT images for 2nd and higher orders have values in [−1,0], −1 is coded as ‘0’ and ‘1’ as black in FIG. 7.

### STATEMENT OF INVENTION

According to an aspect of the present invention, there is provided an image enhancement method comprising:

receiving an input and target image pair, each of the input and target images including data representing pixel intensities;

processing the data to determine a plurality of basis functions, each basis function being determined in dependence on content of the input image;

determining a combination of the basis functions to modify the intensity of pixels of the input image to approximate the target image; and, applying the plurality of basis functions to the input image to produce an approximation of the target image.

The step of processing the data to determine the plurality of basis functions may comprise processing derivatives of the data to determine the plurality of basis functions.

Each basis function may be determined in dependence on one or more content types including: colours in the input image, pixel intensity in the input image or identified or designated shapes or elements in the input image.

Each of the plurality of basis functions, when applied to the input image, preferably decomposes the input image into a corresponding image layer by encoding each pixel of the input image according to the basis function.

The image enhancement function may be an approximation of a predetermined image processing algorithm, the target image comprising an output of the predetermined image processing algorithm and the step of determining including solving an optimization for combining the basis functions to approximate the output of the predetermined image processing algorithm.

The basis functions may be determined according to a binary decomposition to produce k basis functions where at every pixel in the input image one of the basis functions applies to the pixel and the other k-1 basis functions do not apply.

The basis function may be determined according to a non-binary decomposition in which a predetermined distribution function applies and for a given pixel in the input image the basis functions encode the relative probability that the pixel's content is associated with the respective basis function.

The basis functions may be determined according to a continuous distribution in which each basis function is blurred and the output of each basis function is cross bilaterally filtering using the input image as a guide.

The step of determining a combination may comprise solving optimisation of a per channel polynomial transform of the input image to approximate the target image where the polynomial corresponds to the basis functions.

The step of determining a combination may comprise solving optimisation of a full polynomial transform of the input image for each basis function to approximate the target image.

The combination of basis functions may comprises a weighted combination of the basis functions.

The method may further comprise receiving a further input image, determining a plurality of further basis functions for the further input image, the step of determining comprising determining a combination of the basis functions and the further basis functions, the step of applying the basis functions and further basis functions to the input image and further input image according to the combination to fuse the input image and further input image.

Each basis function may be determined from and/or applied to a thumbnail of the input image.

The method may further comprise applying the determining the basis functions for an image of a video and applying the basis functions to subsequent images in the video.

According to another aspect of the present invention, there is provided an image enhancement system comprising:

an input interface configured to receive an input and target image pair, each of the input and target images including data representing pixel intensities;

a processor configured to execute computer program code for processing the data to determine a plurality of basis functions, each basis function being determined in dependence on content of the input image;

the processor being further configured to execute computer program code to determine a combination of the basis functions to modify the intensity of pixels of the input image to approximate the target image and apply the plurality of basis functions to the input image and output an image comprising an approximation of the target image generated from the input image at an output interface.

According to another aspect of the present invention, there is provided an image enhancement method comprising:

receiving a first input image and a second input image, each including data representing pixel intensities of the images and at least a subset of pixels of the second input image corresponding to pixels of the first input image;

processing the data to determine a plurality of basis functions, each basis function being determined in dependence on content of the first input image and from a mask that is dependent on the content, the basis functions being configured to be applied to the first input image to generate a segmented image;

applying the plurality of basis functions to the first input image to generate a corresponding plurality of the segmented images; and, combining the plurality of segmented images and the second input image to generate an output image.

The method may include calculating the mask at a thumbnail resolution.

The method may further comprise applying a semantic segmentation neural network on the input image, using depth estimation information obtained from the input image, or applying another algorithmic or sensor-based method to calculate the mask.

The mask may be a binary image segmentation mask, a non-binary image segmentation mask or a continuous distribution image segmentation mask.

The basis functions preferably include a blurred version of mask, one or more basis functions calculated by eroding the mask and then blurring, and one or more basis functions calculated by dilating the mask and then blurring.

The blurring and dilation are preferably based on a plurality of kernels of different sizes.

The method may further comprise modifying the kernel sizes in dependence on an estimation or analysis of the mask accuracy.

Preferably, the basis functions further include a set of inverted basis functions.

The step of combining may comprise solving a polynomial expansion to determine the combination of the basis functions.

The step of combining may comprise solving a per-colour channel optimisation of the basis functions to determine the output image.

According to another aspect of the present invention, there is provided an image enhancement system comprising:

an input interface configured to receive a first input image and a second input image, each including data representing pixel intensities of the images and at least a subset of pixels of the second input image corresponding to pixels of the first input image;

a processor configured to execute computer program code to processing the data to determine a plurality of basis functions, each basis function being determined in dependence on content of the first input image and from a mask that is dependent on the content, the basis functions being configured to be applied to the first input image to generate a segmented image;

the processor being further configured to execute computer program code to apply the plurality of basis functions to the first input image to generate a corresponding plurality of the segmented images; and, the processor being further configured to execute computer program code to combine the plurality of segmented images and the second input image to generate an output image.

According to an aspect of the present invention, there is provided an image enhancement method comprising:

receiving an input and target image pair, each of the input and target images including data representing pixel intensities;

processing the data to determine a plurality of basis functions, each basis function being determined in dependence on content of the input image;

determining a combination of the basis functions to modify the intensity of pixels of the input image to approximate the target image; and, applying the plurality of basis functions to the input image to produce an approximation of the target image.

The step of processing the data to determine the plurality of basis functions may comprise processing derivatives of the data to determine the plurality of basis functions.

According to another aspect of the present invention, there is provided an image enhancement method comprising:

receiving a first input image and a second input image, each including data representing pixel intensities of the images and at least a subset of pixels of the second input image corresponding to pixels of the first input image;

processing the data to determine a plurality of basis functions, each basis function being determined in dependence on content of the first input image and from a mask that is dependent on the content, the mask being configured to be applied to the first input image to generate a segmented image;

applying the plurality of basis functions to the first input image to generate a corresponding plurality of the segmented images; and, combining the plurality of segmented images and the second input image to generate an output image.

In embodiments of the present invention, various aspects of content may be used to determine the plurality of basis functions. This may include intensity values of pixels, the RGB colours of the pixels, designated, identified or recognized elements or regions within the image (these may be visually recognized, identified by intensity differences or in some other way). The input image may be pre-processed and a derived image used as the basis for determining the basis functions. Sometimes the content of the image that appears in a second image—or more generally ith (of N images)—may also be used to determine the plurality of basis functions (to allow elements to be swapped in from a related image).

Embodiments of the present invention seek to address the problem of computational cost in image enhancement while seeking to deliver strongly detailed output without spatial artifacts. Embodiments also seek to address the need to use a very smooth fixed interpolation scheme in image enhancement applications such as equalisation. Additionally, embodiments seek to provide a method and system that use fewer basis functions compared to prior art approaches while seeking to match or improve on accuracy and consistency with the original image. Embodiments of the present invention select, determine or otherwise choose basis functions per image based on the content in the image itself.

Selected embodiments of the present invention use image segmentation information to perform a variety of image manipulation tasks without border or transition artefacts.

Embodiments of the present invention also seek to improve output image quality for any particular level of segmentation performance.

Using the methods described below, embodiments enable increased levels of fine detail to be preserved in output images without manual intervention.

Selected embodiments of the present invention seek to calculate an output image as a per channel polynomial transform of the image where the polynomial employed varies with the content of the image. In another embodiment a full (including cross terms) polynomial transform of the input image is solved for each content varying basis function.

In one embodiment, the basis (interpolation) functions are proportional to the brightnesses in the image. In another they are dependent on the colours found in an image. Equally, the basis functions may be dependent on other definitions of content as is discussed below.

In contrast to prior techniques that use fixed basis functions, in embodiments of the present invention the plurality of basis functions are selected, calculated, derived or otherwise determined per image, the selection, calculation, derivation or other determination of each basis function being based on the content in the image itself. For example, in an embodiment of the present invention a set of basis functions to intensity equalize one image may be selected/calculated/determined that differs substantially to another set selected/calculated/determined for intensity equalizing another image, the basis functions being selected/calculated/determined from the content of the respective images.

On the whole, embodiments diverge on how the basis functions are selected/calculated/determined from the content of the image depending on whether they concern intensity or content manipulation and these are therefore described separately below.

### BRIEF DESCRIPTION OF THE DRAWINGS

Embodiments of the present invention will now be described, by way of example only, with reference to the accompanying drawings.

FIGS. 1-7 illustrate image enhancement approaches;

FIG. 8 is a flow diagram of an image enhancement method according to one embodiment;

FIG. 9 is schematic diagram of a system for generating an intensity enhanced output image from an input image according to an embodiment;

FIGS. 10-17 are images showing illustrating aspects of image enhancement of embodiments of the present invention;

FIG. 18 is a schematic diagram illustrating aspects of an embodiment;

FIG. 19 is schematic diagram of a system for generating an enhanced output image from an input image according to an embodiment;

FIGS. 20A-20E show example images from an embodiment;

FIGS. 21 and 22 illustrate a method to produce a bokeh effect according to an embodiment;

FIGS. 23A-23C show example images from an embodiment; and,

FIG. 24 illustrates a method to produce a regional zoom effect according to an embodiment.

### DETAILED DESCRIPTION

Intensity Manipulation

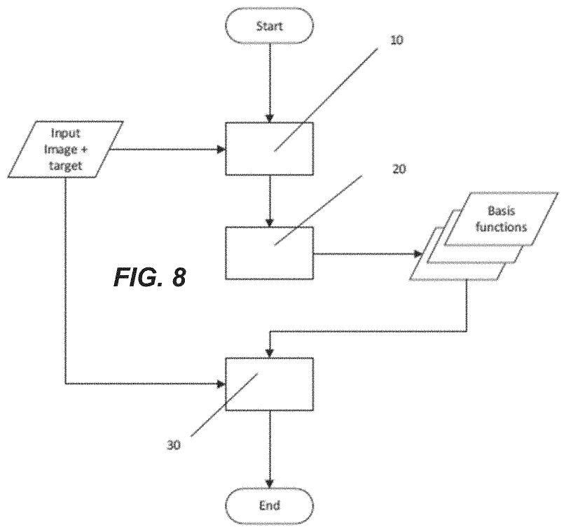

FIG. 8 is a flow diagram of an image enhancement method according to one embodiment.

In step 10, data representing pixel intensities of an input and a target image is received.

In step 20, the data is processed to determine a plurality of basis functions. The plurality of basis functions are selected, calculated, derived or otherwise determined per image based on the content in the image itself. Each basis function is configured to modify the intensity of pixels of the input image to approximate the target image.

In step 30, the plurality of basis functions are applied to the input image to produce an approximation of the target image (referred to here as an enhanced image).

The enhanced image may be written to storage, output to a display, communicated or otherwise output depending on the intended application.

FIG. 9 is schematic diagram of a system 100 for generating an intensity enhanced output image from an input image 101.

The input image 101 may be received via a data communications link or on a storage medium, it may be an image feed from cameras, etc. The input image may be grayscale, colour or multi-spectral and may also be logically composed of a number of images (separately encoded/stored) of the same scene, components of a single or related image feeds, components of a single or related image file etc. The target image 102 may also be received via a data communications link. Alternatively, the target image could be generated by a further system that is provided the input image and applies some predetermined process or algorithm to it. In this case, it is “received” in the sense that it is received from the further system that generates it from the input image—the input image may be the only user input in such an arrangement.

The system includes a processor 110 that obtains data representing pixel intensities of the input image 101 and target image 102. Different intensities can be processed depending on encoding and application. For example, it may be brightness or it may be intensity of a specific colour (or other spectral) channel or some other determinable intensity. It may also be, or include, derivatives.

The processor 110 processes the data to determine a plurality basis functions. The basis functions are determined per image and are determined from the content of the input image and optionally the target image.

Each of the plurality of basis functions, when applied to the image, decomposes the image into a corresponding image layer by encoding each pixel according to its intensity. Each basis function is applied across the entirety of the input image.

Once the basis functions have been obtained, they are applied to the input image and the resultant image layers are combined to generate an intensity modified output image 103 that is an approximation of the target image 102. An example of this is set out in more detail below.

The system 100 also includes the processor 110 and any necessary memory or other components needed for the system 100 to operate and to execute computer program code for executing an image enhancement which performs the above operations.

The output image may be output, for example, via an I/O device or system to memory, a data store, via a network, to a user interface or to an image reproduction device such as a printer or other device for producing a hard-copy. The output image could also serve as an input to other systems.

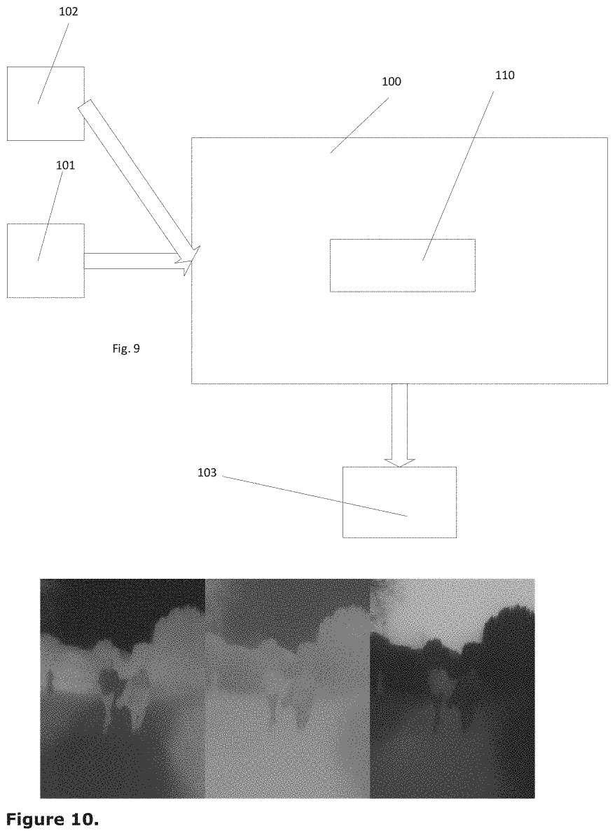

In embodiments of the present invention described below, N image (where N>1) content dependent basis functions are found which ‘appear’ to have a spatial extent, see FIG. 10 (where the number of basis functions is 3). In fact, they are actually intensity varying and wholly image dependent. While three basis functions are discussed in embodiments below, two or more basis functions can be used. It will be appreciated that other numbers of basis functions may be used, although the computational complexity will increase as numbers of basis functions increase. It will be seen from the experimental results below that three basis functions can produce highly acceptable results and with a substantially lower computational burden than prior art systems.

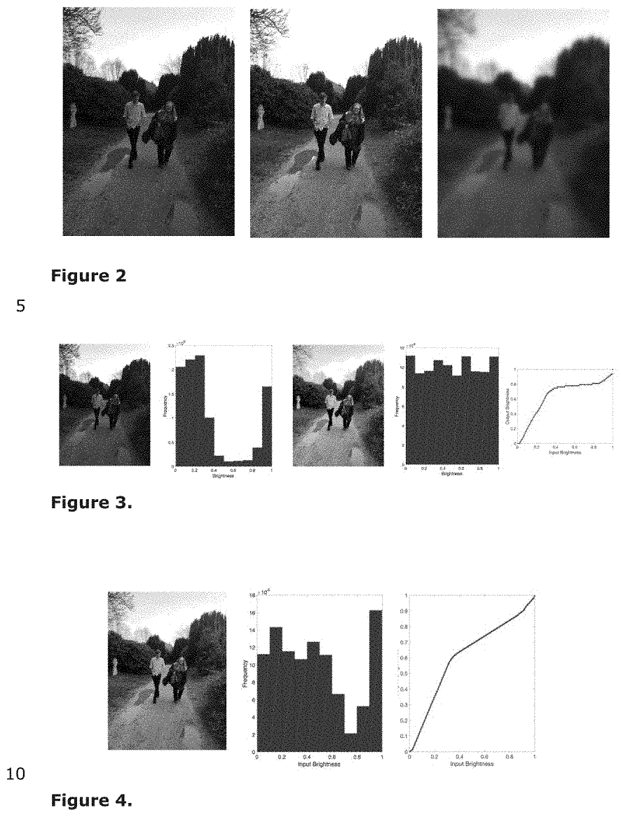

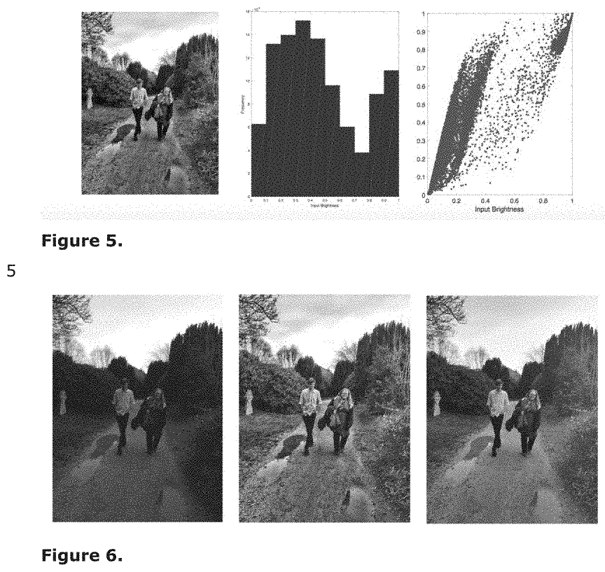

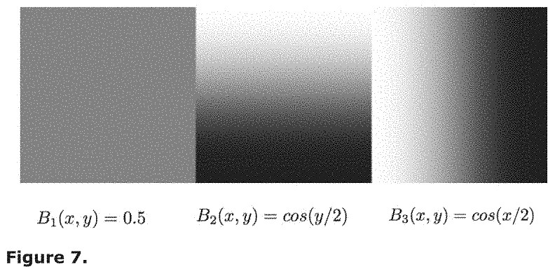

Although the basis functions appear to have a spatial extent, in fact the spatial aspect of the ‘decomposition’ is related to the brightnesses in the original image rather than the basis functions. Indeed, looking at FIG. 2 (left panel) the brightest region is the sky, the darkest region is the trees and the middle brightnesses delimit the foreground region. This intuitive decomposition is reflected in the basis images shown in FIG. 10.

Various ways of determining such a decomposition are possible and are discussed below.

The simplest way is to approximate an image enhancement function by finding a set of k focal brightnesses in an image. These could be evenly spaced quantiles e.g. if k=3, the selected brightnesses could be set at that of the darkest pixel, the 50% brightness pixel, and the 100% brightest pixel. For each of these k focal pixels an intensity specific basis function is made. In the discussion that follows the k focal brightnesses is denoted as b_i (i=1 . . . k)

Binary Decomposition.

The simplest decomposition would be to have k basis functions where at every pixel one basis function is 1 then the other k-1 basis functions are 0. These basis functions could be defined according to:

Bᵢ(x,y)=1iff∥I(x,y)−bᵢ∥<∥I(x,Y)−bⱼ∥,∀j≠i Equation 1

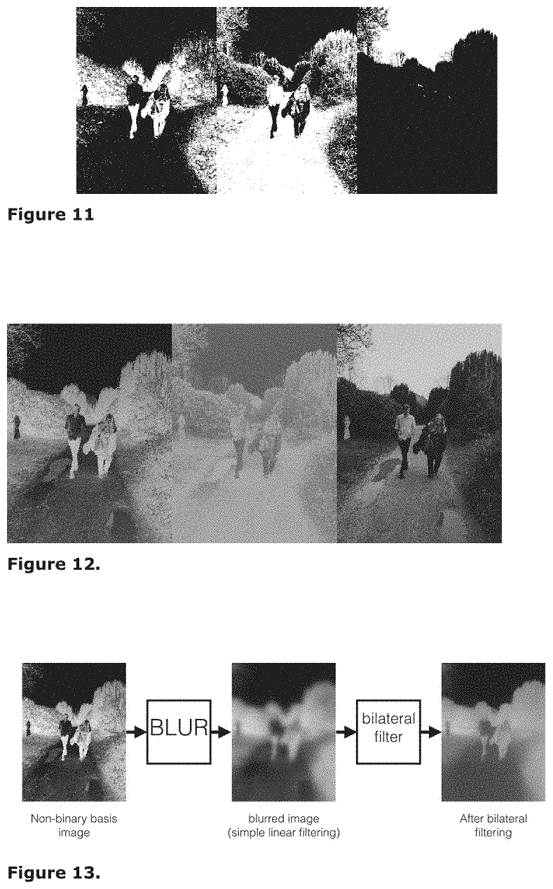

3 binary basis functions are shown in FIG. 11. The ith basis function is 1 if the corresponding ith focal brightness is closest to a given pixel in the input image (input image is shown left, FIG. 2)

Looking at FIG. 11, it is clear that different brightnesses tend to be spatially clustered in the images. The binary decomposition (coarsely) finds 3 spatial ‘regions’ of the input image. However, there are places where this is not true (the trees appear in the both the first and second basis functions). Further, the basis functions appear to be affected by noise. This is simply evidence of ‘high-frequency’ changes in the basis function.

Non-Binary Decomposition

Preferred embodiments use non-binary decomposition. The basis functions shown below in FIG. 12 are calculated in two steps. First, for each focal brightness a Normal distribution denoted N(bᵢ,σᵢ) is calculated. Here the standard deviation is chosen empirically (but could, for example, be 1/k if the number of focal brightness is k).

Given a ‘query’ brightness I(x,y) its ‘probability’ is calculated according to the Normal distribution, which is denoted Pᵢ (x,y). Given the k probability images Pᵢ(x,y) the intensity varying basis functions can be calculated as

$${B}_{i} ( x , y ) = \frac{{P}_{i} ( x , y )}{{\sum }_{j = 1}^{k} {P}_{j} ( x , y )} \qquad Equation 2$$

Of course any reasonable probability function could be used. For a given pixel in the input image the basis functions encode the relative probability that the pixel's brightness is associated with the ith focal brightness.

Continuous Decompositions

The non-binary decomposition shown in FIG. 12 is smoother and appears to be more spatially coherent compared to the binary distribution shown in FIG. 10. Yet the maps are not continuous and the edge definition between semantic regions is not as well defined. To enforce continuity each basis function is blurred in selected embodiments. Edge definition can be imposed by post processing the non-binary decomposition. For example, by blurring the basis functions shown in FIG. 11 and then cross bilaterally filtering the outputs (using the input image as a guide) the continuous decomposition shown in FIG. 10 can be produced. The process of converting a non-binary decomposition (images shown in FIG. 12) to the final intensity varying basis functions is illustrated in FIG. 13.

It has been found that basis functions which are smoothly varying but with good edge definition at ‘semantic’ edges in the input image under analysis often provide the best image enhancement results. However, all three intensity varying discussed decompositions (binary, non-binary and continuous) can be used directly with good effect.

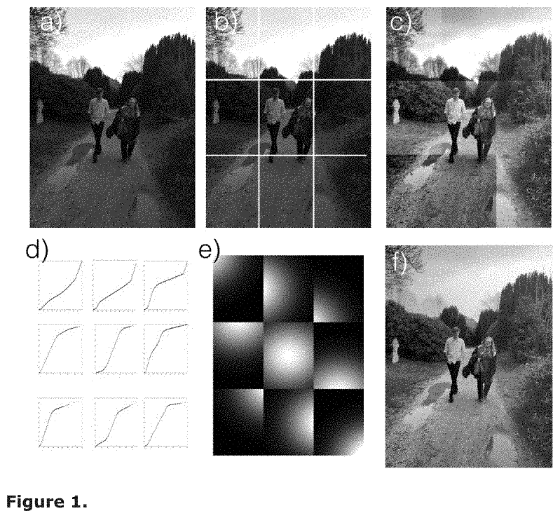

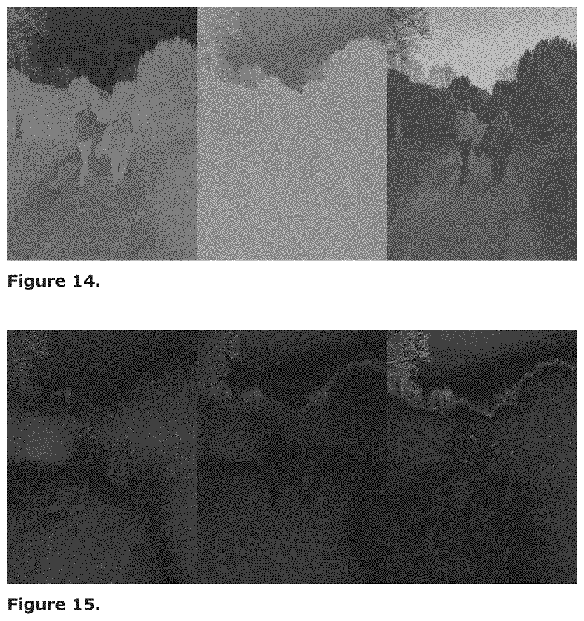

In FIG. 14, the approximations of the basis functions from FIG. 8 are shown. Each basis function here is selected to be a simple global function from the input brightness image. Three basis functions shown. These images are a global function of the input image (left, FIG. 1). They are strictly and only intensity varying.

In FIG. 15 the absolute difference between FIG. 14 and FIG. 10 is shown. Save top left (the fine detail in the branches of the tree) the functions that only vary in intensity (FIG. 15) are surprisingly similar to those derived and shown in FIG. 10.

In one embodiment, intensity varying functions are used to approximate image processing functions.

Suppose that I′(x,y)=f(I(x,y)) where f( ) is an algorithm which spatially processes the image. The algorithm f( ) could be configured to, for example: increase contrast (e.g. Contrast Limited Histogram Adaptive Histogram Equalisation, discussed previously); to compress dynamic range (https://en.wikipedia.org/wiki/High-dynamic-range_imaging); Or, to add detail to an image (https://en.wikipedia.org/wiki/Unsharp_masking).

The intent here is to approximate the image I′(x,y) in a way that, according to an intensity varying decomposition, is a combination of globally transformed images. Suppose the ith basis function (and ith focal brightness) is approximated by a function fᵢ( ) This function maps input to output brightnesses (f( ) may be monotonically increasing, see FIG. 1). Solving for the functions fᵢ( ) that minimizes:

$${min}_{{f}_{i} 0} {\sum }_{i = 1}^{k} {‖ {f}_{i} ( I ( x , y ) ) {B}_{i} ( x , y ) - {I}^{′} ( x , y ) ‖}^{2} \qquad Equation 3$$

In one embodiment, Equation 3 is solved using standard linear optimization techniques. As an example if fᵢ( ) is a polynomial of the form aᵢ+bᵢI(x,y)+cᵢI(x,y)² then for a given image the optimization in Equation 3 is solved for k*3 coefficients. Constraints may also be added to the optimization. For example, constraints may force the functions fᵢ( ) to be monotonically increasing or the solution to be regularized.

An approximation J(x,y) to I′(x,y) is written as

$$J ( x , y ) = {\sum }_{i = 1}^{k} {f}_{i} ( I ( x , y ) ) {B}_{i} ( x , y ) \qquad Equation 4$$

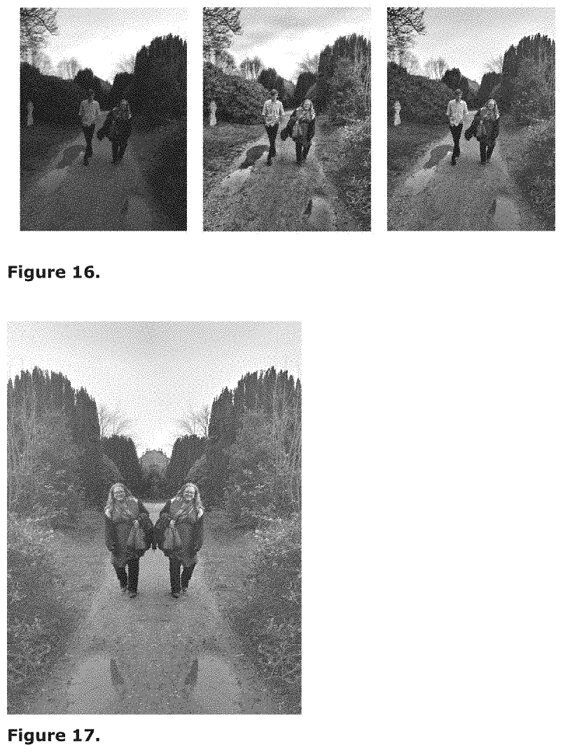

The intensity varying approximation—using 3 intensity varying basis functions—CLAHE output is shown in FIG. 16. The left-hand panel shows the input image, middle panel shows the output from CLAHE and right-hand panel the Intensity Varying Approximation. The intensity varying approximation of CLAHE presents a good comprise between (apparent) spatially varying contrast enhancement where artifacts have not been introduced.

FIG. 17, compares, on the left, the output from a spatially varying image approximation (with fixed discrete cosine basis functions) to the intensity varying counterparts discussed here (in the right side of the image). The extra detail returned from embodiments of the present invention is evident. This confirms that the basis functions varying with the image content produces advantageous image enhancement results in comparison to prior methods.

Embodiments of the present invention may advantageously be applied to video sequences. However, while it is possible to apply Equations 3 and 4 to each frame of a video, it is also possible to solve for the functions fᵢ( ) for a given frame (time t) and then use only Equation 4 at time T+U (U>0) where, at time T+U only the intensity varying basis functions would need to be recalculated.

Embodiments of the present invention can also be applied to content dependent image fusion.

Suppose there are N input images that to be fused to form an M-dimensional output (where M<N). It is also assumed that there exists an M-dimensional ‘guide’. For example, given an input image with N=4 channels, R, G, B and NIR (Near Infrared), the goal of image fusion is to make an RGB fused output image (M=3) where the original RGB image is used as the guide. In the paper by David Connah, Mark S. Drew, and Graham D. Finlayson, “Spectral edge: gradient-preserving spectral mapping for image fusion,” J. Opt. Soc. Am. A 32, 2384-2396 (2015) (the content of which is herein incorporated by reference), a method is disclosed for generating a M dimensional target derivative image (which fuses the derivatives from the input and the guide).

In EP 2467823, the content of which is herein incorporated by reference, a method is disclosed for finding a polynomial function of the input N-channel image that best approximates target derivatives such as those found in the paper discussed above.

This approach can be generalised so that per pixel the weighted combination of k (corresponding to our k intensity varying basis functions) polynomial mappings is found. The optimization to be solved can be written as:

$${min}_{{ }^{{\underline{t}}^{j}}} {\sum }_{i = 1}^{k} ‖ [ ∇ {P}^{o} ( \underline{I} ( x , y ) ) ] {\underline{t}}^{j} {B}_{i} ( x , y ) - ∇ {I}_{j}^{′} ( x , y ) ‖$$

Equation 5

In the above equation P^{o} ( ) is a polynomial expansion (including cross terms). The superscript ‘o’ denotes the order of the polynomial. If o=1, then this is a first order polynomial i.e. the N channel input image itself. When o=2 there is the original image plus each channel squared plus the products of all pairs of channels. For a 4 channel input image when o=2, there are 14 terms in the polynomial expansion (or 15 if we add an offset them). The ∇ symbol, or ‘Del’, denotes x- and y-derivatives. ∇Iᵢ′(x,y) denotes the x- and y-derivatives found through derivative domain image fusion (e.g. the Spectral Edge method), an output image to be approximated according to our method. The vector t^{j} denotes a vector of coefficients (which are applied to—dot producted with—the terms in the polynomial expansion). If o=2 then each tⁱ is a 14 (or 15) term vector. If the output image has M channels then j ϵ[1, 2, . . . , M], M (per channel) optimisations are carried out).

An approximation J(x,y) to I′(x,y) is written as

$${J}_{j} ( x , y ) = {\sum }_{i = 1}^{k} {P}^{o} ( \underline{I} ( x , y ) ) {\underline{t}}^{j} {B}_{i} ( x , y ) \qquad Equation 6$$

Where j ϵ[1, 2, . . . , M] Notice in Equation 5 we solve for the optimization in the derivative domain but apply the discovered parameters to the primal image (i.e. not derivatives).

Equation 5 can be solved using standard linear optimization techniques. As an example if t^{j} is a polynomial with 15 terms (N=4, 0=2 and we have an offset) then it is solved for k*15 coefficients. Constraints can optionally be added to the optimization such as the coefficients are bounded or the solution is regularized.

The equations can be solved for derivative for a single channel image (see Equations 7 and 8 below). Here the polynomial function generates an expansion of the scalar image eg. P²(I(x,y))=[I(x,y) I²(x,y) 1] (where 1 is an image with the offset 1 everywhere in the image).

Equations 5 and 6 then become equations 7 and 8, respectively:

$$\begin{matrix}{min}_{{\underline{t}}^{j}} {\sum }_{i = 1}^{k} ‖ [ ∇ {P}^{o} ( I ( x , y ) ) ] {\underline{t}}^{j} {B}_{i} ( x , y ) - ∇ {I}_{j} ( x , y ) ‖ & Equation 7 \\ {J}_{j} ( x , y ) = {\sum }_{i = 1}^{k} {P}^{o} ( I ( x , y ) ) {\underline{t}}^{j} {B}_{i} ( x , y ) & Equation 8\end{matrix}$$

As with earlier embodiments, this embodiment can be applied to video sequences but now to a video image fusion problem (e.g. a surveillance application where RGB+NIR is fused to RGB).

As before, Equations 5 and 6 could be applied by both the equations per frame. However, it is also possible to solve for the coefficients for a given frame (time T) and then just use Equation 6 at time T+U (U>0) where, at time T+U the intensity varying basis functions would need to be recalculated.

The approaches discussed above can be further extended in various ways.

For example, in one embodiment, non-binary basis functions can be determined from clustering brightnesses.

Non-binary intensity varying basis functions can be thought of as a set of brightnesses closest to a focal brightness (see binary decomposition). Put another way, 3 clusters of pixels could be defined based on brightness where the ‘cluster centers’ are a priori known. Finding the cluster centers as part of the optimisation is also possible. The exemplar ‘Fuzzy c-means’ method described in Bezdec, J. C., Pattern Recognition with Fuzzy Objective Function Algorithms, Plenum Press, New York, 1981, the content of which is hereby incorporated by reference in its entirety, optimises for the cluster center and also returns the fractions to each cluster (that a given image brightness belongs)

In another embodiment, non-binary basis functions can be determined by clustering RGBs.

The Fuzzy c-means method can also be applied to RGB images—k cluster centers can be found which are RGB vectors. A probability/extent to which each image RGB belongs to each cluster is obtained. The ith non-binary basis image encodes the probability that a given pixel belongs to the ith cluster.

It will be appreciated that other clustering algorithms can also be used.

Embodiments may also combine content with spatial locality.

If RGB denotes an image pixel then by adding the xy location to the pixel a 5 tuple is obtained: [R G B cx cy] where c here is a scalar which modifies the magnitude of the x y coordinate. By fuzzy c-mean clustering on this 5-tuple, clusters can be found that are also weighted by spatial location.

In the extensions discussed above, the output of the clustering method is a set of basis functions where, per pixel, an all positive vector (which sums to 1) indicates how much the colour (or other feature) at that pixel corresponds to the basis functions. As for the spatially varying basis functions, it is advantageous for each basis function to be continuous and have good edge definition.

Embodiments may also use basis functions that correspond to semantic regions found through image analysis.

There are many ways image specific regions might be encoded. For example, deep learning such as SegNet described in Vijay Badrinarayanan, Alex Kendall and Roberto Cipolla “SegNet: A Deep Convolutional Encoder-Decoder Architecture for Image Segmentation.” PAMI, 2017, the content of which is hereby incorporated by reference in its entirety, may be used. This technique maps image points to one of k predefined classes. The output of SegNet could easily be converted into a binary basis (where the ith basis function is set to 1 iff that pixel is classified as belonging to the ith class).

In preferred embodiments, the basis functions found by clustering or semantic analysis are post-processed in 3 steps. First, each function is blurred (it has been found that fairly small blur kernels (say a 9×9 Gaussian with standard deviation 1.5 pixels) can work well). Second, blurring is performed again with a cross bilateral filter, where ‘cross’ means the edge strength is taken from a guide image (in this case the original image). The guide can be greyscale or colour. Third, the processed images are, per-pixel, scaled so that the sum of the basis functions at that point is 1. Effectively the workflow illustrated in FIG. 13 is applied (for image basis functions found using colour or semantic content as opposed to brightness).

In a further embodiment, thumbnails may be used to reduce computational load. It will be appreciated that solving for the functions (Equation 3) or the polynomials used in image fusion (Equation 5) can be an expensive operation. Where processing time or utilisation is important, in one embodiment the functions and coefficients can be solved based on an input and output image thumbnail. The discovered functions and polynomials can then be applied to the full resolution image.

It will be appreciated that Equation 4 (the application of the functions found in Equation 3) and Equation 6 (the application of the polynomials found in Equation 5) need full resolution basis functions (whereas only thumbnails are required in Equations 3 and 5).

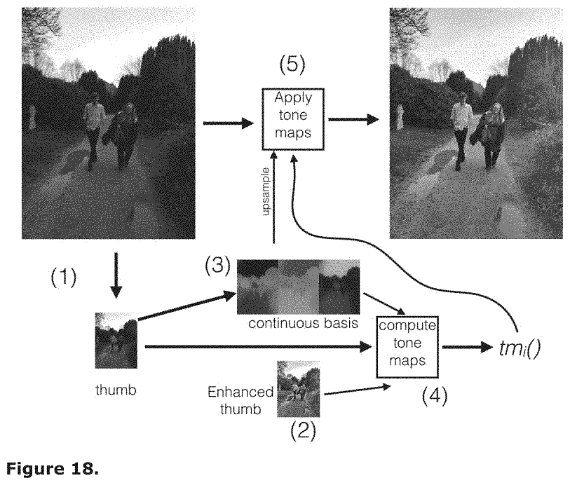

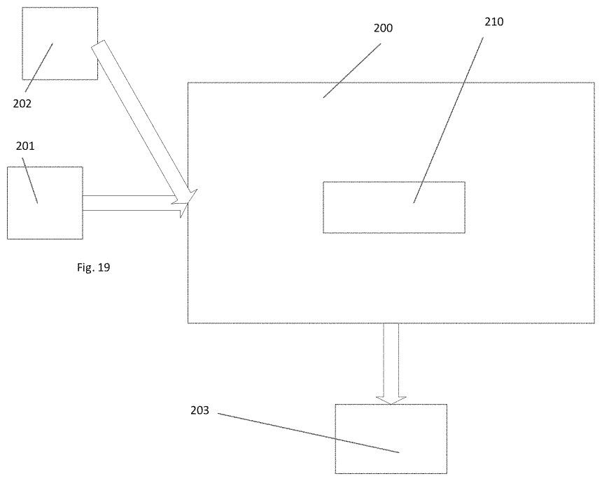

Basis functions are preferably determined that have good edge definition and are smooth (see FIG. 10, for example). Thus, in one embodiment the thumbnail basis functions used in solving Equations 3 and 5 can be simply up-sampled (e.g. using bilinear image resizing) to be applied in Equations 4 and 6. Thumbnails with as few as 4, 10 or 20K pixels can be used with good processing performance. Thumbnail processing is summarized in FIG. 18.

In step (1) An input image is converted to a thumbnail. At step (2) the thumbnail is processed. In step (3) using the thumb image we calculate a content varying image decomposition (3 basis functions here). In step (4) based on (1), (2) and (3) we calculate a set of (3) tone maps. In step (5), based on the calculated tone curves and a simply upsampled version of the content varying basis (computed in the thumbnail domain) we generate the output image.

A similar strategy can be used for image fusion applications.

Content Manipulation

FIG. 19 is schematic diagram of a system 200 for generating an enhanced or altered output image from first and second input images, based on the content (e.g. foreground/background, people, faces, objects, animals etc.).

The first input image 201 may be received via a data communications link or on a storage medium, it may be an image feed from cameras, etc. The first input image may be grayscale, colour or multi-spectral and may also be logically composed of a number of images (separately encoded/stored) of the same scene, components of a single or related image feeds, components of a single or related image file etc.

A second input image 202 is also received or generated. The second input image 202 includes modifications to be applied to the first input image 201. For example, it may be a version of the first input image zoomed and cropped (to match the size of the input image) so as to provide a zoomed version of an object to be replaced in the first input image 201. In another alternative, it may be an image in which the first input image that has been processed with a blurring kernel to simulate an optical bokeh effect, or any other pattern etc. In another alternative, the second input image may not be directly derived from the first input image—it might, for example, be a later image in a sequence having the same image size and many features in common but where a person's eyes are not closed, or an alternative background to replace the background of the input image.

Note that which of the input images is masked depends on the application. For example, in the case of bokeh, the non-bokeh input image may be masked to retain the areas to be kept in focus and those areas are then applied to replace the corresponding pixels in the bokeh version of the input image. In the case of zooming, the object(s) of interest in the zoomed image may be preserved in the mask and then applied to replace the corresponding pixels in the non-zoomed input image. It will therefore be appreciated that the terms “first” and “second” input image below may vary as to which image is referred to.

The system includes a processor 210 that obtains an image segmentation mask from the content of the first input image. The image segmentation mask may be calculated at the full image resolution, or at a lower thumbnail resolution for reduced computational complexity. The mask may be produced using a semantic segmentation neural network, from depth estimation information, or from any other algorithmic and/or sensor-based method.

In the two embodiments described below, a binary image segmentation mask is used as it provides sharp and specific region outlines. The binary representation is shown by black and white segmentation areas with black areas being one segmentation area and white being the other. However, it will be appreciated that other types of image segmentation mask may be used such as a smoothly-varying greyscale segmentation mask—this may represent properties such as continuous probability functions.

The image segmentation mask is selected so as to divide the first input image into areas which each have a desired target state: they are selected to mask portions of one of the input images so that when combined with the other input image the modifications replace the original content but the remainder of the original content remains. There is no specific requirement as to which mask identifies which area (so in the case of the binary mask discussed above, black could designate areas to be unchanged or replaced).

The processor 220 then calculates a plurality of basis functions from the segmentation mask—each function consists of a weight for each pixel location X,Y of between 0 and 1. As described below, this can be done at full-resolution or thumbnail size (if calculated at thumbnail size, the basis functions are upscaled before being applied to the input image(s)).

The first basis function B₁(x,y) is typically a blurred version of the segmentation mask (this can be either Gaussian filtering, a cross bilateral filter with the input RGB image used as the guide/edge image, or a combination of the two). N other basis functions can be calculated by eroding the input mask with various kernel sizes and then blurring, and M are preferably calculated by dilating the input mask with various kernel sizes and then blurring. N and M are typically small numbers e.g. N=M=3. The exact set of kernel sizes can be adjusted depending on the application and based on estimates of the segmentation mask accuracy. In one embodiment, the kernel sizes are based on a multiple of the image dimensions. E.g. if the image is 1000×1000, the kernel may be X*1000, if X=0.05 then the kernel sizes would be multiples of 50 (50, 100, 150, . . . ) —if the basis functions are calculated at thumbnail resolution, then X is multiplied by the thumbnail image size to produce the kernel size.

The inverses (1−basis) (i.e. 1−Bᵢ(x,y)) of the set of basis functions are then produced, and added to the set of basis functions.

A target image is calculated as described below based on alpha blending—this can be done at full-resolution or thumbnail size. The segmentation mask is multiplied at each pixel by the relevant image, then its inverse (1−mask) is multiplied at each pixel by the other image, and finally the two are added together. This is an approximation of what the output image should look like—however it comes with a sharp border and will likely contain artefacts. Which of the two input images is applied to the mask and its inverse depends on the mask itself.

In the case of regional zoom described below, if white pixels of the binary segmentation mask are used to represent the foreground/object of interest (in the zoomed, secondary image), and black pixels to represent the background (non-object areas) to be retained in the input image, then the mask would be multiplied per-pixel with the input image of the modified (zoomed) content and its inverse with the input image of the non-modified content and the two added together to produce the target image.

In the case of simulated bokeh, again described below, if white pixels of the binary segmentation mask are used to represent the image area which should remain in focus (e.g. the foreground) in the output image, and black pixels to represent areas on which a simulation of optical blur should be applied (e.g. the background), then the mask here would be multiplied per-pixel with the non-modified input image, and its inverse to the input image having the bokeh effect and the two added together to produce the target image.

The X and Y gradients of this target image are then calculated for each of the RGB channels (it will be appreciated this can also be applied to greyscale or other representations of channels). These gradients and the first and second input images are fused together guided by the basis functions, and the target image. One way of fusing is described above in connection with equations 5 and 6. The target image gradients correspond to VI, in equation 5. This produces an output image 203 with smooth and improved transitions.

Bokeh

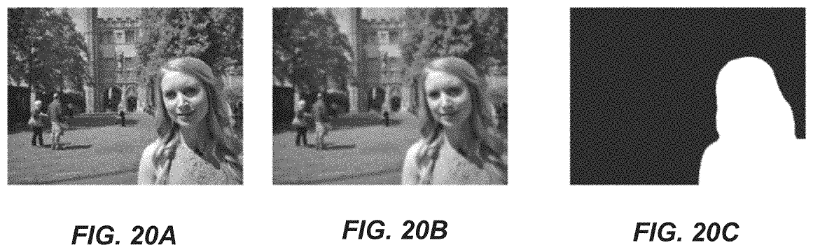

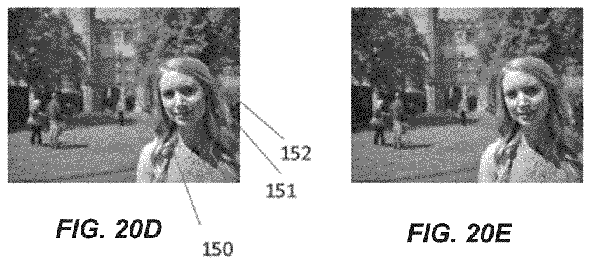

In FIG. 20A there is shown an example high resolution, first, input image and in FIG. 20B a blurred, second, input image (which may be provided as an input or something computationally generated from the first input image). In this embodiment, the intention is to retain the first input image areas for the person but elsewhere in the output image blend in the blurred background of the second input image as a simulated bokeh effect (in photography, bokeh is often achieved optically by using a shallow depth of field to cause areas that are not the primary subject of the image to be out of focus, in a way that is considered visually pleasing as they do not then distract from the primary subject of the image).

It is assumed there is a rough segmentation and it will be appreciated there are many ways to obtain this. This is the binary mask shown in FIG. 20C and again may be provided or computationally generated).

As described above, a target alpha blended image can be made where the first input image is retained when the mask is 1 and the second input image is used when the mask is 0. This is shown in FIG. 20D (and denoted I′(x,y)). Because the mask is not (and cannot be) precise the blended output image looks unnatural and the mask location is clearly perceived. Note that the hair 150 and 152 is too sharp around the mask edges and also there is some haloing 151 present.

In embodiments of the present invention, a plurality of basis functions are formed from the segmentation mask. In equation 5, a plurality of basis functions are calculated based on the intensity decomposition. These can be replaced, in this embodiment of the invention, with blurred, eroded and dilated version of the segmentation mask and its inverses.

As discussed above, these masks are made smoother by blurring and then cross bilateral filtering (where the original image is used as a guide) and these basis functions are shown in FIGS. 20A-20E (the original mask being shown on the left hand side and on the right hand side from top to bottom there is the blurred, cross-bilateral filtered version (B₁(x,y)); the eroded, blurred, cross-bilateral filtered version (B₂(x,y)); and, the dilated, blurred, cross-bilateral filtered version (B₃(x,y)).

Additional functions can be added to this set by varying the size of the blurring and/or erosion or dilation kernels.

Returning to Equation 5, it can be seen that a polynomial expansion is used to generate a set of images. In one embodiment, this expansion is not needed. Rather—per color channel—a new image Qᵢ(i=1,2) is used where Q₁ is the original image and Q₂ is the blurred variant (for each colour channel). The following optimisation can then be solved to determine the fused image (where Bᵢ(x,y) denote the segmentation based basis functions):

$$\begin{matrix}{min}_{{\underline{t}}^{j}} {\sum }_{i = 1}^{k} ‖ [ ∇ \underline{ Q} ( x , y ) ] {\underline{t}}^{j} {B}_{i} ( x , y ) - ∇ {I}_{j} ( x , y ) ‖ & Equation 9 \\ {J}_{j} ( x , y ) = {\sum }_{i = 1}^{k} \underline{Q} ( x , y ) {\underline{t}}^{j} {B}_{i} ( x , y ) & Equation 10\end{matrix}$$

The final fused image is show in in FIG. 20E.

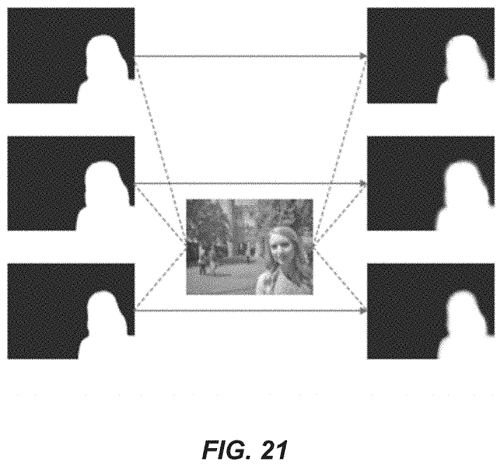

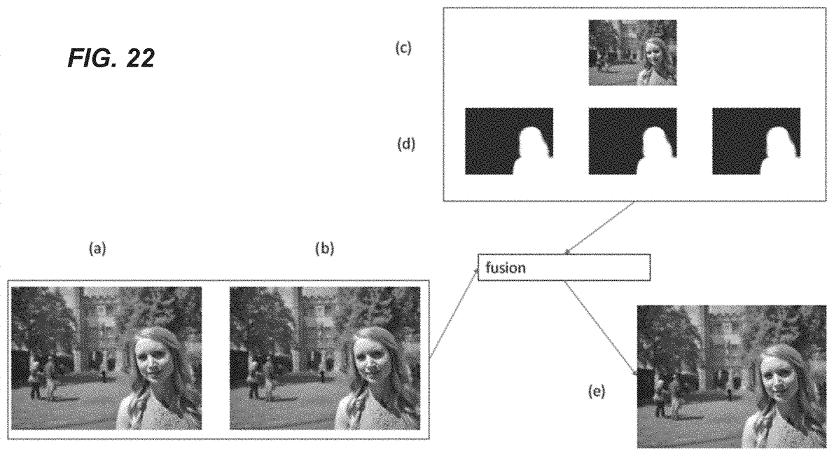

Aspects of the overall workflow of an embodiment of the present invention applying a blurred background to an image to produce a bokeh effect can be seen in FIGS. 21 and 22.

Full-size inputs are received in the form of a first (non-blurred) input image (a) and a second (blurred) input image (b)

Here, basis functions are based on the segmentation mask (d) and an alpha blend (target) (c). Three functions are created: the thumbnail of the input mask, as well as eroded and dilated versions. These are then passed through a cross bilateral filter, in this embodiment with the original input image luminance channel used as the guide image as shown in FIG. 21. This set is combined with the set of their inverses to produce the final basis functions.

As described above, the first input image and second input image are then fused guided by the basis functions and target to produce an output image as shown in FIG. 22, using equations 9 and 10. The basis functions may be in the form of thumbnails.

It will be appreciated that patterns other than blurring can be used to simulate other forms of bokeh or image effects. The blurring kernel for the background is, in this case, a combination of Gaussian and bilateral filtering. Other blurring kernels can be used, such as those designed to more closely approximate optical blur.

Regional Zoom

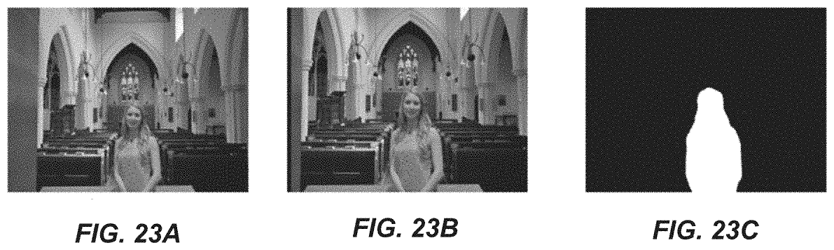

In FIG. 23A there is shown an example high resolution, first, input image and in FIG. 23B a zoomed and cropped variant (the second input image which may be provided as an input or something computationally generated from the first input image). In this embodiment, the intention is to retain the first input image for the background but blend in the zoomed version of the person from the second input image.

It is again assumed there is a rough segmentation. This is the binary mask shown in FIG. 23C and again may be provided or computationally generated.

In embodiments of the present invention, a plurality of basis functions are formed from the segmentation mask. The starting point is again the segmentation mask and its inverse.

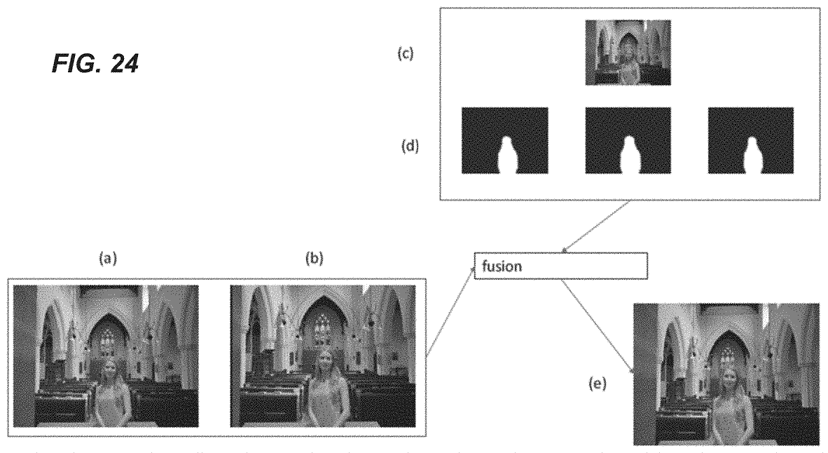

As discussed above, these masks are made smoother by blurring and then cross bilateral filtering (where the original image is used as a guide) and these basis functions are shown in FIG. 24. These masks are referred to as B₁(x,y) (blurred original mask), B₂(x,y) (blurred eroded mask) and B₃(x,y) (blurred dilated mask) and again the optimisation of Equation 10 can be solved to obtain the fused image.

Aspects of the workflow of an embodiment of the present invention applying a regional zoom to produce a modified image can be seen in FIG. 24. This is a similar process to that in FIG. 22. Full-size first input image (a) and a second (zoomed+cropped) input image (b) are received or otherwise obtained.

Here, the segmentation mask designates the object/region in the input image that is zoomed. The mask may be produced using a semantic segmentation neural network, from depth estimation information, or from any other algorithmic and/or sensor-based or other method.

The mask is processed as described above to produce the various basis functions and then used to produce the target image. As described above, the first input image and second input image are then fused under the guidance of the basis functions and target image to produce an output image.

Segmentation Mask Pre-Processing

Segmentation masks can often have errors, and this will affect the performance of content manipulation. To help overcome this, embodiments may pre-process the segmentation mask.

In one embodiment, the mask is blurred with an edge-sensitive filter (e.g. a cross bilateral filter), with the original input RGB image luminance channel used as the edge/guide image.

If a binary segmentation mask is desired (as in the cases of bokeh and regional zoom), a threshold is applied to the blurred mask, above which the values are set to 1, and equal to and below which they are set to 0. Typically, this is set to 0.5, but other values may be used depending on the application.

Automatic Regional Zoom Calculation

The zoomed image and mask used in regional zoom may be manually constructed by enlarging and cropping the input image and segmentation mask based on user preference, but an automatic method is also possible.

Firstly, the maximum dimension (height or width) of the object of interest is calculated, and the ratio of the image size that this represents. A scaling parameter based on preferred image characteristics (e.g. the “rule of thirds” https://en.wikipedia.org/wiki/Rule_of_thirds) is then calculated.

The input image is enlarged based on this scaling parameter and the centre of the object shifted back to the original location.

The original object should be fully covered by the enlarged object when they are superimposed—e.g. all object pixels in the original image should lie inside the border of the object in the enlarged image. If this is not the case, embodiments may search for the image shift parameters which minimize this phenomenon. Finally, the enlarged image is cropped to match the input image dimensions.

The same scaling, shifting and cropping parameters are applied to the input segmentation mask, and this is then used for further calculations.

If there are residual errors in overlapping original and zoomed objects, the segmentation mask at those pixels can be set to 1 (white), to prevent unwanted elements of the original object being transferred to the output image.

Other Applications

Embodiments of the present invention may apply content modification including:
Combining faces from similar photos—in many cases there will be several photos of a group of people, but no individual photo has the ideal face appearance for all members of the group. Two photos can be merged using the proposed algorithm, with the mask designating the desired face area(s) to be replaced. This can be repeated for multiple photos. The images must be registered correctly (within a few pixels' tolerance).
Background replacement—a foreground (e.g. a person) may be combined with a different background (e.g. the Eiffel tower). Here the segmentation mask is used similarly to that of bokeh, designating the foreground area.

It will be appreciated that the processor described above may be local to a user, remote or distributed. Embodiments may take many forms and be implemented in many ways including incorporation within smartphones, digital cameras and the like by way of firmware, software or hardware, provision as a web-based service by a remote server, as software or plug-ins to image editing software, etc. It will also be appreciated that the processor discussed herein may represent a single processor or a collection of processors acting in a synchronised, semi-synchronised or asynchronous manner.

It is to be appreciated that certain embodiments of the invention as discussed above may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims and equivalents thereof.

1. An image enhancement method comprising:
receiving an input and target image pair, each of the input and target images including data representing pixel intensities;
processing the data to determine a plurality of basis functions, each basis function being determined in dependence on content of the input image;
determining a combination of the basis functions to modify the intensity of pixels of the input image to approximate the target image; and
applying the plurality of basis functions to the input image to produce an approximation of the target image.

2. The method of claim 1, wherein the step of processing the data to determine the plurality of basis functions comprises processing derivatives of the data to determine the plurality of basis functions.

3. The method of claim 1, wherein each basis function is determined in dependence on one or more of: colors in the input image, pixel intensity in the input image or identified or designated shapes or elements in the input image.

4. The method of claim 1, wherein each of the plurality of basis functions, when applied to the input image, decomposes the input image into a corresponding image layer by encoding each pixel of the input image according to the basis function.

5. The method of claim 1, wherein the target image comprises an output of the predetermined image processing algorithm, and the step of determining includes solving an optimization for combining the basis functions to approximate the output of the predetermined image processing algorithm.

6. The method of claim 1, wherein the basis functions are determined according to a binary decomposition to produce k basis functions where, at every pixel in the input image, one of the basis functions applies to the pixel, and the other k-1 basis functions do not apply.

7. The method of claim 1, wherein the basis function are determined according to a non-binary decomposition, in which a predetermined distribution function applies and, for a given pixel in the input image, the basis functions encode the relative probability that the pixel's content is associated with the respective basis function.

8. The method of claim 1, wherein the basis functions are determined according to a continuous distribution, in which each basis function is blurred and the output of each basis function is cross bilaterally filtered using the input image as a guide.

9. The method of claim 1, wherein the step of determining a combination comprises solving optimization of a per-channel polynomial transform of the input image to approximate the target image, where the polynomial corresponds to the basis functions.

10. The method of claim 1, wherein the step of determining a combination comprises solving optimization of a full polynomial transform of the input image for each basis function to approximate the target image.

11. The method of claim 1, in which the combination of basis functions comprises a weighted combination of the basis functions.

12. The method of claim 1, further comprising receiving a further input image, determining a plurality of further basis functions for the further input image, the step of determining comprising determining a combination of the basis functions and the further basis functions, the step of applying the basis functions and further basis functions to the input image and further input image according to the combination to fuse the input image and further input image.

13. The method of claim 1, wherein each basis function is determined from a thumbnail of the input image.

14. The method of claim 1, further comprising determining the basis functions for an image of a video and applying the basis functions to subsequent images in the video.

15. An image enhancement system comprising:
an input interface configured to receive an input and target image pair, each of the input and target images including data representing pixel intensities;
a processor configured to execute computer program code for processing the data to determine a plurality of basis functions, each basis function being determined in dependence on content of the input image;
the processor being further configured to execute computer program code to determine a combination of the basis functions to modify the intensity of pixels of the input image to approximate the target image and apply the plurality of basis functions to the input image and output an image comprising an approximation of the target image generated from the input image at an output interface.

16. The system of claim 15, wherein the code for processing the data to determine the plurality of basis functions comprises code for processing derivatives of the data to determine the plurality of basis functions.

17. The system of claim 15, wherein each of the plurality of basis functions, when applied to the input image, decomposes the input image into a corresponding image layer by encoding each pixel of the input image according to the basis function.

18. The (system of claim 15, wherein the basis function are determined according to a non-binary decomposition, in which a predetermined distribution function applies and, for a given pixel in the input image, the basis functions encode the relative probability that the pixel's content is associated with the respective basis function.

19. The system of claim 15, wherein the basis functions are determined according to a continuous distribution, in which each basis function is blurred and the output of each basis function is cross bilaterally filtered using the input image as a guide.

20. The system of claim 15, wherein the code to determine a combination comprises code to solve an optimization of a per-channel polynomial transform of the input image to approximate the target image, where the polynomial corresponds to the basis functions.
